(19) United States
(12) Patent Application Publication
(10) Pub. No.: US 2024/0113959 A1
(43) Pub. Date: Apr. 4, 2024

(54) INSTANCE-AFFINE SERVICE SCHEDULING

(71) Applicant: HUAWEI TECHNOLOGIES CO., LTD., Shenzhen (CN)

(72) Inventors: Dirk Trossen, Munich (DE); Ramin Khalili, Munich (DE)

(21) Appl. No.: 18/534,222

(22) Filed: Dec. 8, 2023

Related U.S. Application Data
(63) Continuation of application No. PCT/EP2021/065833, filed on Jun. 11, 2021.

(51) Int. Cl. H04L 45/125

(52) U.S. Cl. CPC H04L 45/125

(57) ABSTRACT

A routing device includes a controller configured to establish a first forwarding state for an initial packet of a flow of packets to one or more of a plurality of instances of a service function and receive a packet of the flow of packets. If the received packet does not match a second forwarding state for subsequent packets of the flow of packets, the routing device establishes the second forwarding state to a particular one of the one or more of a plurality of instances of the service function, and prepares to send the received packet to a next hop in accordance with the first forwarding state. If the received packet matches the second forwarding state, the routing device prepares to send the received packet to the next hop in accordance with the second forwarding state.

### CROSS-REFERENCE TO RELATED APPLICATIONS

This application is a continuation of International Application No. PCT/EP2021/065833, filed on Jun. 11, 2021, the disclosure of which is hereby incorporated by reference in its entirety.

### FIELD

The present disclosure relates to instance-affine service scheduling in view of multiple instances of a service function. In particular, the present disclosure specifically relates to a routing device, a server device, a service management device, and corresponding methods of operating such devices.

### BACKGROUND

In a typical scenario, a client C issues a request to service SF, which request may be served by any one of multiple service instances SF₁, . . . , SFᵢ that are deployed at various network locations, and which request requires a mapping to a particular one of the multiple service instances.

A stateful service may be ‘sticky’ in that once a particular service instance has been selected, the flow of packets relating to the requested service may need to be routed to this service instance due to state being built up. By contrast, a stateless service such as file retrieval for over-the-top (OTT) video may be provided by ever-changing service instances in response to each request.

Centralized service scheduling approaches may be deployed in data centers, for example, and use a centralized scheduler to map service requests to service instances. This may be done at load balancer level, while service scheduling across a number of network locations may also be done at application level, e.g., based on IETF ALTO approaches. As will be appreciated, centralized scheduling may ensure that compute capabilities are best used, and at the same time may constitute a performance bottleneck and thus give rise to scalability concerns.

Distributed scheduling approaches may, for example, be deployed in the context of Service Function Chaining (SFC) for runtime scheduling of traffic through instantiated service functions. Instead of an ingress routing function, embedded in-service function chaining may be used based on Service Function Forwarders (SFF) with direct SFF-to-SFF relation. Alternatively, an underlying routing service may be used to map service requests to service instances in dependence of well-considered metrics. For example, a routing protocol such as the Enhanced Interior Gateway Routing Protocol (EIGRP, see RFC 7868) may be deployed within autonomous systems (AS) to calculate loop-free route(s) to all other destinations and identify the best route to a respective destination in terms of the lowest sum of link metrics along the particular route. Evidently, distributed approaches make it more difficult to ensure that compute capabilities are best used, may be subject to frequent signaling of any decision-making metrics, and may experience request latencies.

### SUMMARY

The present disclosure provides systems and methods for providing an appropriate service instance to serve a client's request, while distributing requests from more than one client in a manner that compute capabilities are appropriately used and request latency is constrained as well as avoiding a centralized scheduler as well as frequent signaling of any decision-making metrics.

A first aspect of the present disclosure relates to a routing device for routing a flow of packets to a service function. The routing device comprises a control unit. The control unit is configured to establish a first forwarding state for an initial packet of the flow of packets to one or more of a plurality of instances of the service function. The first forwarding state comprises a unique index of a normalized capacity of processing units of the one or more of the plurality of instances of the service function. The control unit is further configured to receive a packet of the flow of packets. The packet comprises a semantic identifier of a service function indicative of a destination address. The control unit is further configured to establish a second forwarding state to a particular one of the one or more of the plurality of instances of the service function, and prepare a sending of the received packet to a next hop towards the particular one of the one or more of the plurality of instances of the service function in accordance with the first forwarding state, if the received packet fails to match the second forwarding state for subsequent packets of the flow of packets. The control unit is further configured to prepare a sending of the received packet to the next hop towards the particular one of the one or more of the plurality of instances of the service function in accordance with the second forwarding state, and send the received packet to the next hop, if the received packet matches the second forwarding state.

So as to establish the first forwarding state to the one or more of the plurality of instances of the service function, the control unit may further be configured to: receive, from an adjacent device, an advertised unique index of a normalized capacity of processing units of the particular one of the one or more of the plurality of instances of the service function, and a semantic identifier of the service function; and populate a routing table with the semantic identifier of the service function, the unique index and the adjacent device as a next hop.

So as to establish the first forwarding state to the one or more of the plurality of instances of the service function, the control unit may further be configured to re-advertise the unique index and the associated semantic identifier.

So as to prepare the sending of the received packet to the next hop towards the particular one of the one or more of the plurality of instances of the service function in accordance with the second forwarding state, the control unit may further be configured to: retrieve the next hop from an instance table in dependence of the received semantic identifier of the service function and a forwarding information of a header of the packet as an identifier of the particular one of the one or more of the plurality of instances of the service function; and proceed to send in response to the next hop being valid.

So as to establish the second forwarding state to the particular one of the one or more of the plurality of instances of the service function in accordance with the first forwarding state, the control unit may further be configured to: compare a respective processing load of any local instances of the one or more of the plurality of instances of the service function with a given threshold, the respective local instance being identified by a reception of its unique indices via a local link; if the processing load of a particular one of the local instances does not exceed the given threshold, populate the instance table with the semantic identifier of the service function, the forwarding information of the header of the packet as the identifier of the particular one of the local instances, and a destination address of the particular one of the local instances as the next hop; and proceed to send.

So as to establish the second forwarding state to the particular one of the one or more of the plurality of instances of the service function in accordance with the first forwarding state, the control unit may further be configured to: retrieve an instance iterator associated with the semantic identifier of the service function from the routing table; and store the iterated instance iterator in the routing table. The instance iterator may be configured to iterate through the unique indices associated with the semantic identifier of the service function in the routing table.

So as to establish the second forwarding state to the particular one of the one or more of the plurality of instances of the service function in accordance with the first forwarding state, the control unit may further be configured to retrieve an instance iterator associated with the semantic identifier of the service function from the received packet.

So as to establish the second forwarding state to the particular one of the one or more of the plurality of instances of the service function in accordance with the first forwarding state, the control unit may further be configured to: retrieve the next hop from the routing table in dependence of the semantic identifier of the service function and the instance iterator as the unique index; and populate the instance table with the semantic identifier of the service function, the forwarding information of the header of the packet as the identifier of the particular one of the one or more of the plurality of instances of the service function, and the retrieved next hop.

So as to prepare the sending of the received packet to the next hop towards the particular one of the one or more of the plurality of instances of the service function in accordance with the first forwarding state, the control unit may further be configured to: insert the instance iterator into the packet; and proceed to send.

A second aspect of the present disclosure relates to a method of operating a routing device. The method comprises establishing a first forwarding state for an initial packet of a flow of packets to one or more of a plurality of instances of a service function. The first forwarding state comprises a unique index of a normalized capacity of processing units of the one or more of the plurality of instances of the service function. The method further comprises receiving a packet of the flow of packets. The packet comprises a semantic identifier of a service function indicative of a destination address. The method further comprises establishing a second forwarding state to a particular one of the one or more of the plurality of instances of the service function, and preparing a sending of the received packet to a next hop towards the particular one of the one or more of the plurality of instances of the service function in accordance with the first forwarding state, if the received packet fails to match a second forwarding state for subsequent packets of the flow of packets. The method further comprises: preparing a sending of the received packet to the next hop towards the particular one of the one or more of the plurality of instances of the service function in accordance with the second forwarding state; and sending the received packet to the next hop, if the received packet matches the second forwarding state.

The method may be performed by the routing device of the first aspect or any of its implementations.

A third aspect of the present disclosure relates to a server device, comprising: one or more of a plurality of instances of a service function, the one or more instances respectively having a normalized capacity of processing units; and a control unit configured to establish a first forwarding state for an initial packet of a flow of packets to the one or more of the plurality of instances of the service function. The first forwarding state comprises a unique index of a normalized capacity of processing units of the one or more of the plurality of instances of the service function. The control unit is further configured to receive a packet of the flow of packets. The packet comprises a semantic identifier of a service function as a destination address.

So as to establish the first forwarding state to the one or more of the plurality of instances of the service function, the control unit may further be configured to: advertise the normalized capacity of processing units of the one or more of the plurality of instances of the service function; receive a unique index for each advertised normalized capacity of processing units of the one or more of the plurality of instances of the service function; and advertise the respective unique index and a semantic identifier of the service function.

A fourth aspect of the present disclosure relates to a method of operating a server device. The method comprises: establishing a first forwarding state for an initial packet of a flow of packets to the one or more of the plurality of instances of the service function. The first forwarding state comprises a unique index of a normalized capacity of processing units of the one or more of the plurality of instances of the service function. The method further comprises receiving a packet of the flow of packets. The packet comprises a semantic identifier of a service function indicative of a destination address.

The method may be performed by the server device of the third aspect or any of its implementations.

A fifth aspect of the present disclosure relates to a service management device, comprising a control unit configured to: establish a first forwarding state for an initial packet of a flow of packets to one or more of a plurality of instances of a service function. The first forwarding state comprises a unique index of a normalized capacity of processing units of the one or more of the plurality of instances of the service function.

So as to establish the first forwarding state to the one or more of the plurality of instances of the service function, the control unit may further be configured to: receive the normalized capacity of processing units of the one or more of the plurality of instances of the service function; form a tuple comprising an element for each unit of the normalized capacity of processing units of the one or more of the plurality of instances of the service function; and send, to the respective instance of the one or more of the plurality of instances of the service function, a unique index of each element of the tuple that is associated with the respective instance.

A sixth aspect of the present disclosure relates to a method of operating a service management device, comprising: establishing a first forwarding state for an initial packet of a flow of packets to one or more of a plurality of instances of a service function. The first forwarding state comprises a unique index of a normalized capacity of processing units of the one or more of the plurality of instances of the service function.

The method may be performed by the service management device of the fifth aspect or any of its implementations.

A seventh aspect of the present disclosure relates to a computer program, comprising executable instructions which, when executed by a processor, cause the processor to perform the method of the second aspect, fourth aspect, or sixth aspect or any of their implementations.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

The present disclosure provides devices and methods for instance-affine service scheduling in view of multiple instances of a service function, and more specifically, for routing a flow of packets to a specific service instance of the service function.

Instance affinity as used herein may relate to the concept that one or more packets have to be sent to the same service instance. The reason for this may be that, e.g., an application protocol (like HTTP) may require more than one packet for delivery of a service request. Another reason may be that a certain number of service requests create ephemeral state at the service instance, so that selecting another service instance in-between would destroy this state and render the following service requests useless. As a consequence, packets belonging to the same flow will be queued for output to the particular service instance the initial flow packet has been assigned to. Separate queues may be provided per ingress routing device 1 for clients 5 belonging into different service classes, e.g., defined as various latencies or service classes (gold, silver, . . . ) for forwarding of priority-based traffic.

It will be appreciated that determining which packets belong to the same flow, i.e., where the boundaries for the flow are in terms of packets, is not within the scope of the present disclosure. Furthermore, the means for signaling such instance affinity are also not within the scope of this disclosure. For example, explicit marking of the flow start and end may be used, or client-layer indications like TCP connection set up and teardown signals.

The present disclosure interprets the service scheduling problem as one in a stochastic processing network (SPN). The underlying theoretical framework of SPNs leads to optimal usage of processing capability with constrained latency. Based on the provided devices and methods, a most appropriate service instance to serve a client's request may be selected in terms of a local instance, if available, or a remote instance, wherein the clients' requests are distributed in a manner that compute capabilities are best used.

A request latency may be constrained by preparatory signaling/advertisement of (first) forwarding state for initial packets of a flow of packets and the afore-mentioned provision of separate queues.

The service scheduling may be entirely distributed, i.e., no centralized scheduler is used, where the service request dispatching is done in each ingress point, possibly even at service clients directly.

The service scheduling may rely on the advertised routing information being stable since it can be assumed that the assignment of processing units to service instances is usually longer lived and won't need frequent updates through advertisements. Thus, frequent signaling of routing metrics is avoided as well. However, said assignment of processing units may well change over time, e.g., due to re-assignment of compute resources to specific service instances through changes in overall service management.

The service scheduling, and thus the routing decision, may be based on integer value comparison, which keeps the router implementation simple, i.e., based on simple constraint matching function.

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary scenario in accordance with the present disclosure;

FIGS. 2A, 2B illustrate a protocol behavior of an ingress routing device in accordance with the present disclosure at different levels of detail;

FIGS. 3A, 3B illustrate a protocol behavior of a routing device in accordance with the present disclosure at different levels of detail;

FIGS. 4A, 4B illustrate a protocol behavior of a server device in accordance with the present disclosure at different levels of detail;

FIGS. 5A, 5B illustrate a protocol behavior of a service management device in accordance with the present disclosure at different levels of detail; and

FIG. 6A, 6B illustrate an interaction of the devices of FIGS. 2a-5b at different levels of detail.

### DETAILED DESCRIPTIONS OF EMBODIMENTS

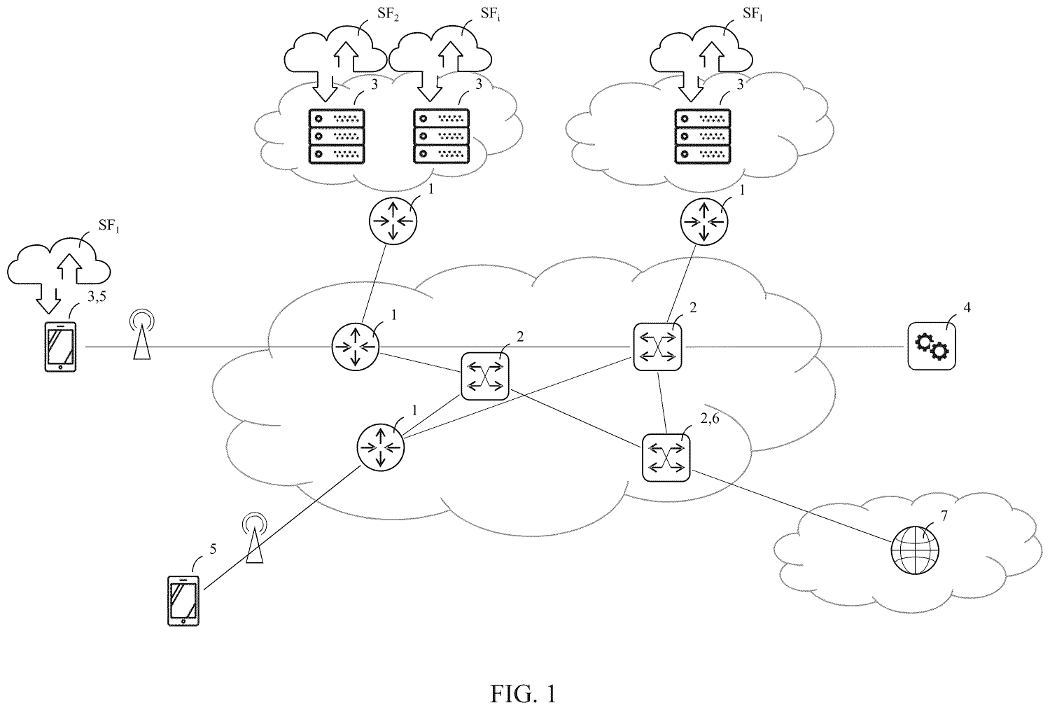

FIG. 1 illustrates an exemplary scenario in accordance with the present disclosure.

The scenario comprises a communication network indicated by a cloud shape and comprising routing devices 1, 2 interconnected by layer-3 network links. In other words, the communication network is a routed network, such as an IP network. As such, the routing devices 1, 2 may collectively implement a semantic routing, and the communication network may further comprise an IP gateway 6 in layer-3 communication with a peering IP network 7.

The communication network is surrounded by server devices 3 deployed at various network locations such as data centers, which are indicated by cloud shapes as well. The server devices 3 collectively host multiple instances SF₁, SF₂, SFᵢ, . . . , SF_{I} of a service function SF indicated by cloud shapes having input/output arrows.

The communication network is further surrounded by client devices 5. The client devices 5 may implement a semantic routing as well. The client devices 5 may request the service provided by the service function SF. For example, if one of the client devices 5 indicated on the left side of FIG. 1 requests the service of service function SF, the request may be served by any one of the multiple service instances SF₁, . . . , SF_{I} hosted by the server devices 3. Accordingly, the client's request requires a mapping to a particular one of the multiple service instances SF₁, . . . , SF_{I}.

This mapping may collectively be implemented by the routing devices 1, 2 and the server devices 3 with the assistance of a service management device 4, which is indicated on the right side of FIG. 1.

Technically, the routing devices at the data centers do not need to be of type 1 in the above scenario, assuming that the service instances SF are purely receiving packets (not initiating own requests, i.e., act as clients to other functions). In other words, ingress routing devices 1 only exist when client devices 5 are attached.

It may be appreciated that routing of service requests can be realized as extensions within solutions such as (i) constraint-based service routing, (ii) suitable IPv6 header extensions or (iii) IP anycast (with service identifier mapping to IP anycast address).

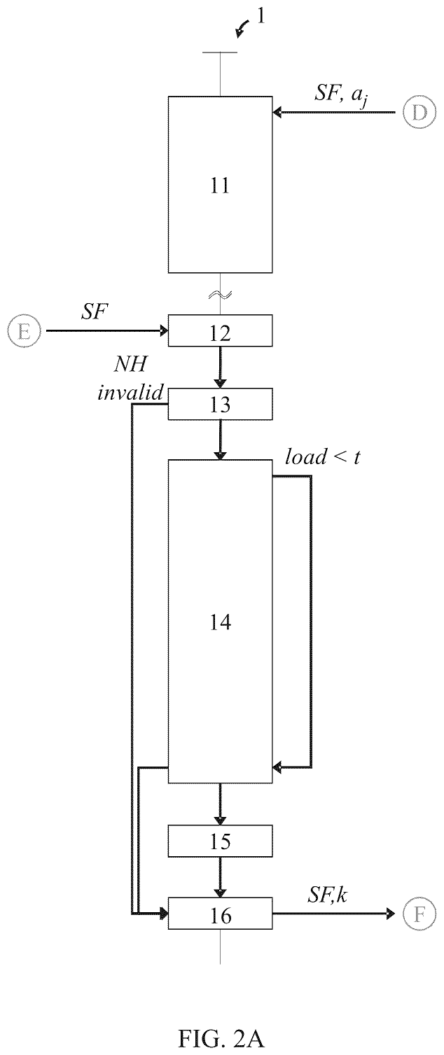

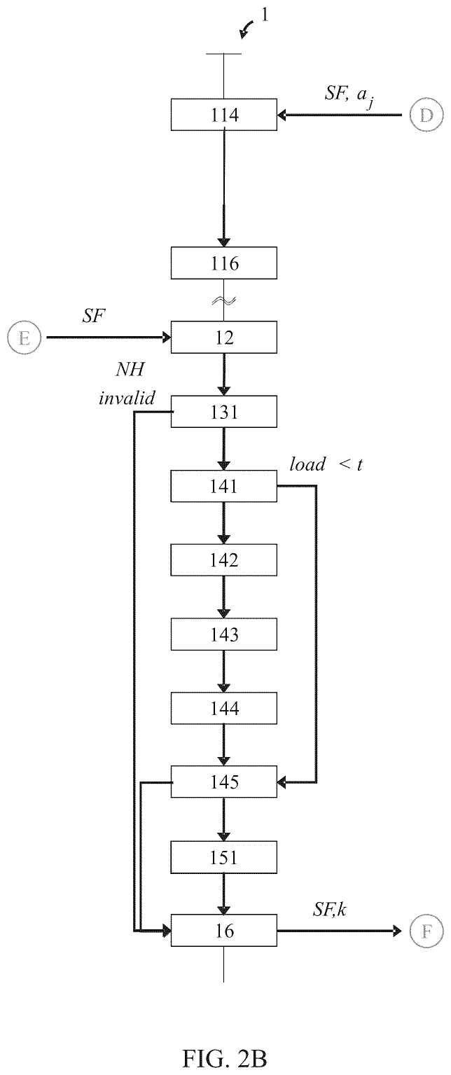

The devices 1-4 and their interaction will be explained in more detail with reference to FIGS. 2a-6b below.

FIGS. 2A, 2B illustrate a protocol behavior of a routing device 1 in accordance with the present disclosure at different levels of detail.

“Routing devices” as used herein may generally relate to network nodes suitable for layer-3 routing a flows of packets to a service function, and as such capable of semantic routing. However, depending on respective role(s) of the routing devices 1, 2 different protocol behaviors apply. A protocol behavior of ingress routing devices 1 is required in adjacency to client devices 5, i.e., at a respective ingress into the communication network. The behavior of checking for a local load only applies to the client device 5 in FIG. 1 that is also hosting the service instance SF₁, since it initiates a service request upon which the ingress routing device 1 checks if the request could simply be served locally. For the second client 5 in FIG. 1, that check is not done since there are no local service instances. A protocol behavior of common routing devices 2 is required otherwise. The routing devices at the data centers (see FIG. 1) are generally of type 2 since they simply forward the request but do not make a scheduling decision (since the request is just forwarded, i.e., coming from another routing device, not from a client) but may also be of type 1 in case that the local server devices 3 are client devices 5 towards other service functions not shown in the example scenario of FIG. 1. In other words, in reality it is very likely to have routing devices of type 1 and type 2 at the entrance to the data center, using type 2 for requests coming from the network and type 1 for requests coming from the data center. Any routing device may be configured to exhibit the protocol behaviors of ingress routing devices 1 and/or common routing devices 2 depending on their role(s) within the particular scenario.

Ingress routing devices 1 get to know processing state of all locally connected service instances SFᵢ and make a service scheduling decision. Key here for routing devices of type 1 is to make a scheduling decision. The routing devices at the data center (see FIG. 1) do not make such decision but simply forward the request coming from another routing device 2.

The ingress routing device 1 of FIGS. 2A, 2B comprises a control unit (not shown). The control unit is configured to perform a sequence of steps numbered 11-16. In more detail:

The control unit is configured to: establish 11 a first forwarding state for an initial packet of the flow of packets to one or more of a plurality of instances i of the service function.

The first forwarding state for the initial packet of the flow of packets relates to a routing table having entries of the form (SF; aⱼ; NH).

Each entry includes a semantic identifier SF of a particular service function, a unique index aⱼ, and a next hop NH, i.e., an address of an adjacent device 2, 3 from which the semantic identifier SF and the unique index aⱼ have been received, as is indicated in FIGS. 2A, 2B by incoming signal/message (D).

The unique index aⱼ relates to a unit of processing assigned to the particular service function as follows:

The service function identified by the semantic identifier SF may comprise one or more of a plurality of instances i. The respective instance may in turn comprise a capacity of units of processing. The processing rate may be assumed to be the same across all server devices 3, or may be used to normalize the respective capacity of processing units, so that the respective instance is associated with a normalized capacity cᵢ of processing units.

For example, two service instances SF₁, SF₂ of service function SF are respectively assigned n₁=10, n₂=20 processing units having respective processing rates r₁=1, r₂=¼. Thus, service instance SF₁ has a normalized capacity of cᵢ=n₁·r₁=10·1=10 units of processing, and service instance SF₂ has a normalized capacity of c₂=n₂·r₂=20·¼=5 units of processing, resulting in a normalized capacity of c₁+c₂=15 units of processing for the service function SF.

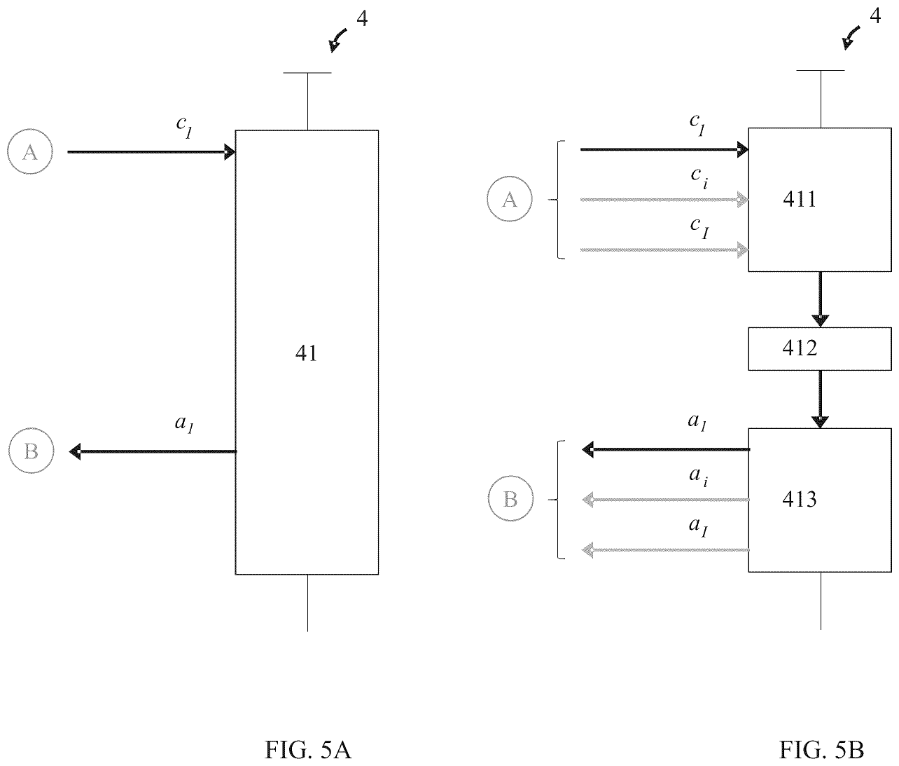

As will be explained in more detail in connection with FIGS. 5A, 5B below, each unit of processing of the service function SF is assigned a respective index aⱼ that is unique for the service function SF.

The first forwarding state—i.e., the routing table—comprises a unique index aⱼ of a normalized capacity cᵢ of processing units of the one or more of a plurality of instances i of the service function SF.

With reference to FIG. 2B, so as to establish 11 the first forwarding state to the one or more of a plurality of instances i of the service function, the control unit may further be configured to: receive 114, from an adjacent device 2, 3, the advertised unique index aⱼ of the normalized capacity cᵢ of processing units of the particular one i of the one or more of a plurality of instances of the service function, and a semantic identifier SF of the service function; and populate 116 the routing table (SF; aⱼ; NH) with the semantic identifier SF of the service function, the unique index aⱼ and the adjacent device 2, 3 as the next hop NH.

The control unit is further configured to: receive 12 a packet of the flow of packets, as is indicated in FIGS. 2A, 2B by incoming signal/message (E).

The packet is a semantically addressed packet, i.e., it comprises a semantic identifier SF (such as a hashed URL) of a service function indicative of a destination address.

Subsequently, the routing device 1 determines whether the received packet constitutes a new flow of packets or belongs to a known flow of packets.

A new flow of packets would be indicated by no match of the received packet in a second forwarding state for subsequent packets of the flow of packets.

The second forwarding state for subsequent packets of the flow of packets relates to an instance table having entries of the form (SF; SF; NH).

Each routing device 1, 2 is configured to maintain such an instance table, which is used to store the ephemeral relationship of a flow of packets with a specifically chosen service instance i. In other words, once a decision is made for the initial packet of a flow of packets which service instance is to receive this packet, an entry of the instance table will contain this choice for the given flow. If a subsequent packet arrives that has the same flow affinity, i.e., is part of the same flow of packets, the aforementioned entry for said flow is being used to determine the service instance. This ensures instance affinity.

The second forwarding state is established when an initial packet of the flow of packets is received. In other words, if the received packet is an initial packet of the flow of packets, the corresponding second forwarding state for subsequent packets of the flow of packets is not available yet. Conversely, a known flow of packets would be indicated by a match of the received packet in the second forwarding state.

The control unit is thus further configured, if the received packet matches a second forwarding state for subsequent packets of the flow of packets, to: prepare 13 a sending of the received packet to the next hop NH towards a particular one i of the one or more of a plurality of instances of the service function in accordance with the second forwarding state; and send 16 the received packet to the next hop NH, as is indicated in FIGS. 2A, 2B by outgoing signal/message (F). Preparing a sending of a packet comprises buffering said packet, and optionally adding headers and/or fields in existing headers to facilitate its routing.

With reference to FIG. 2B, so as to prepare 13 the sending of the received packet to the next hop NH towards the particular one i of the one or more of a plurality of instances of the service function in accordance with the second forwarding state, the control unit may further be configured to: retrieve 131 the next hop NH from an instance table (SF; SF; NH) in dependence of the received semantic identifier SF of the service function and a forwarding information of a header of the packet as an identifier SF of the particular one i of the one or more of a plurality of instances of the service function; and proceed to send 16 in response to the next hop NH being valid. Preparing a sending of a packet comprises buffering said packet, and optionally adding headers and/or fields in existing headers to facilitate its routing.

The control unit is further configured, if the received packet fails to match the second forwarding state, to: establish 14 the second forwarding state to the particular one i of the one or more of a plurality of instances of the service function, and prepare 15 a sending of the received packet to a next hop NH towards the particular one i of the one or more of a plurality of instances of the service function in accordance with the first forwarding state.

With reference to FIG. 2B, so as to establish 14 the second forwarding state to the particular one i of the one or more of a plurality of instances of the service function in accordance with the first forwarding state, the control unit may further be configured to: compare 141 a respective processing load of any local instances of the one or more of a plurality of instances i of the service function with a given threshold t; if the processing load of a particular one i of the local instances does not exceed the given threshold t, populate 145 the instance table (SF; SFᵢ; NH) with the semantic identifier SF of the service function, the forwarding information of the header of the packet as the identifier SFᵢ of the particular one i of the local instances, and a destination address of the particular one i of the local instances as the next hop NH; and proceed to send 16.

The respective local instance hosted on an adjacent device 3 may be identified by a reception of its unique indices aⱼ via a local network link.

It may be appreciated that local load reporting by service instances SF could be implemented over Internet Control Message Protocol (ICMP), for example.

With still continued reference to FIG. 2B, so as to establish 14 the second forwarding state to the particular one i of the one or more of a plurality of instances of the service function in accordance with the first forwarding state, the control unit may further be configured to: retrieve 142 an instance iterator k associated with the semantic identifier SF of the service function from the routing table; and store 143 the iterated instance iterator k in the routing table. The instance iterator k may be configured to iterate through the unique indices aⱼ associated with the semantic identifier SF of the service function in the routing table.

As used herein, iteration may refer to moving to a next entry of the routing table associated with the semantic identifier SF, or randomly selecting an entry of the routing table associated with the semantic identifier SF. Both variants distribute service requests to service instances evenly, owing to explicit enumeration of individual units of normalized capacities cᵢ of processing units of the service function associated with the semantic identifier SF.

With further continued reference FIG. 2B, so as to establish 14 the second forwarding state to the particular one i of the one or more of a plurality of instances of the service function in accordance with the first forwarding state, the control unit may further be configured to: retrieve 144 the next hop NH from the routing table SF; aⱼ; NH in dependence of the semantic identifier SF of the service function and the instance iterator k as the unique index aⱼ; and populate 145 the instance table (SF; SFᵢ; NH) with the semantic identifier SF of the service function, the forwarding information of the header of the packet as the identifier SF of the particular one i of the one or more of a plurality of instances of the service function, and the retrieved next hop NH.

With ongoing reference FIG. 2B, so as to prepare 15 the sending of the received packet to the next hop NH towards the particular one i of the one or more of a plurality of instances of the service function in accordance with the first forwarding state, the control unit may further be configured to: insert 151 the instance iterator k into the packet; and proceed to send 16.

It may be appreciated that the protocol behavior of ingress routing devices 1 could be implemented directly at the client device 5 (or UE), treating them as ingress nodes similar to those at data centers. In this case, service announcements, i.e., advertisements of unique indices a 1, would be delivered to clients 5, in addition to routing devices 1, 2, possibly even selectively for specific service identifiers only.

A method of operating the above-described routing device 1 may be performed by the routing device 1 of the first aspect or any of its implementations, and comprises the steps already mentioned, viz.: establishing 11, 21 a first forwarding state for an initial packet of a flow of packets to one or more of a plurality of instances i of a service function. The first forwarding state comprises a unique index aⱼ of a normalized capacity cᵢ of processing units of the one or more of a plurality of instances i of the service function. The method further comprises: receiving 12 a packet of the flow of packets. The packet comprises a semantic identifier SF of a service function indicative of a destination address. The method further comprises: establishing 14 the second forwarding state to a particular one i of the one or more of a plurality of instances of the service function, and preparing 15 a sending of the received packet to a next hop NH towards the particular one i of the one or more of a plurality of instances of the service function in accordance with the first forwarding state, if the received packet fails to match a second forwarding state for subsequent packets of the flow of packets. The method further comprises: preparing 13 a sending of the received packet to the next hop NH towards the particular one i of the one or more of a plurality of instances of the service function in accordance with the second forwarding state; and sending 16 the received packet to the next hop NH, if the received packet matches the second forwarding state.

Advantageously, the technical effects and advantages described above in relation with the routing device 1 of the first aspect equally apply to the method having corresponding features.

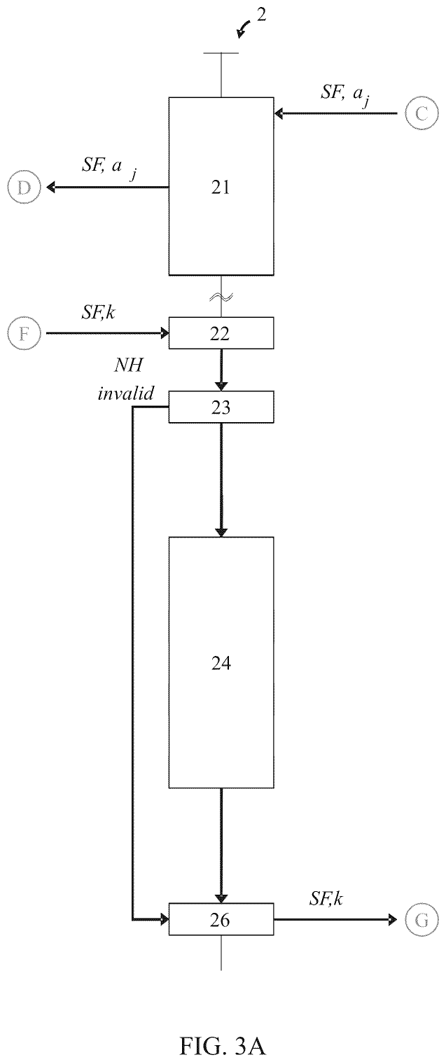

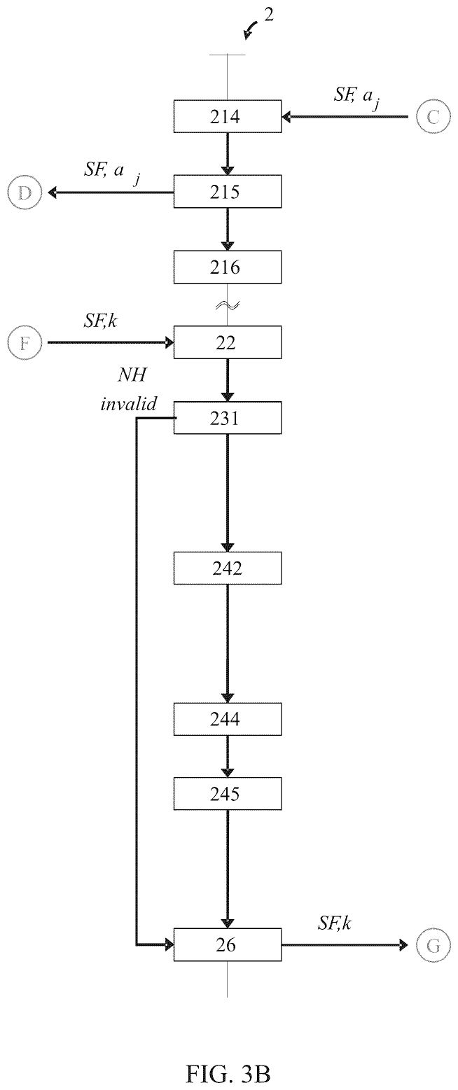

FIGS. 3A, 3B illustrate a protocol behavior of a routing device 2 in accordance with the present disclosure at different levels of detail.

Common routing devices 2 forward service requests based on (i) service identification and (ii) a matching function ƒ(aⱼ, k) where aⱼ is an advertised value for each service instance and k is a matching value provided in the service request.

The common routing device 2 of FIGS. 3A, 3B comprises a control unit (not shown). The control unit is configured to perform a sequence of steps numbered 21-24 and 26, which are similar or identical to the corresponding steps numbered 11-14 and 16 mentioned in connection with ingress routing device 1 of FIG. 2A. Thus, only variations with respect to the protocol behavior of the ingress routing device 1 are described in the following in more detail.

Steps 21, 214 and 216 correspond to steps 11, 114 and 116 previously mentioned in connection with the routing device 1. Additionally, so as to establish 21 the first forwarding state to the one or more of a plurality of instances of the service function, the control unit may further be configured to: re-advertise 215 the unique index aⱼ and the associated semantic identifier SF, as is indicated in FIGS. 3A, 3B by outgoing signal/message (D).

Step 22 corresponds to step 12 previously mentioned in connection with the routing device 1, but it should be noted that besides the semantic identifier SF of the service function indicative of a destination address, the received packet further comprises an instance iterator k associated with the semantic identifier SF of the service function, as is indicated in FIGS. 3A, 3B by incoming signal/message (F).

Steps 23 and 231 correspond to steps 13 and 131 previously mentioned in connection with the routing device 1.

Step 24 differs from step 14 previously mentioned in connection with the routing device 1 in that the different role of the routing device 2 results in a few redundant sub-steps:

First, since the routing device 2 does not have an adjacency to a client device 5 by definition, it does not have any local instances of the one or more of a plurality of instances i of the service function, so that a protocol behavior corresponding to step 141 previously mentioned in connection with the routing device 1 is unnecessary.

Second, unlike the ingress routing device 1, the routing device 2 does not have to distinguish between initial and subsequent packets of a flow of packets on its own. Instead, the received packet comprises an instance iterator k determined by the routing device 1 and relating to one of the unique indices aⱼ associated with the semantic identifier SF of the service function. Accordingly, a protocol behavior corresponding to steps 142 and 143 previously mentioned in connection with the routing device 1 is unnecessary, too.

Instead, so as to establish 24 the second forwarding state to the particular one i of the one or more of a plurality of instances of the service function in accordance with the first forwarding state, the control unit may further be configured to: retrieve 242 an instance iterator k associated with the semantic identifier SF of the service function from the received packet.

Steps 244 and 245 correspond to steps 144 and 145 previously mentioned in connection with the routing device 1.

Steps 15 and 151 previously mentioned in connection with the routing device 1 are redundant in connection with the routing device 2, since the routing device 2 does not have to insert the instance iterator k into the packet.

Step 26 corresponds to step 16 previously mentioned in connection with the routing device 1, as is indicated in FIGS. 3A, 3B by outgoing signal/message (G).

A method of operating a routing device 2 may be performed by the routing device 2 and comprises the steps already mentioned, viz.: establishing 21 a first forwarding state for an initial packet of a flow of packets to one or more of a plurality of instances i of a service function. The first forwarding state comprises a unique index aⱼ of a normalized capacity cᵢ of processing units of the one or more of a plurality of instances i of the service function. The method further comprises: receiving 22 a packet of the flow of packets. The packet comprises a semantic identifier SF of a service function indicative of a destination address. The method further comprises: establishing 24 the second forwarding state to a particular one i of the one or more of a plurality of instances of the service function, if the received packet fails to match a second forwarding state for subsequent packets of the flow of packets. The method further comprises: preparing 23 a sending of the received packet to the next hop NH towards the particular one i of the one or more of a plurality of instances of the service function in accordance with the second forwarding state; and sending 26 the received packet to the next hop NH, if the received packet matches the second forwarding state.

Advantageously, the technical effects and advantages described above in relation with the routing device 2 of the first aspect equally apply to the method having corresponding features.

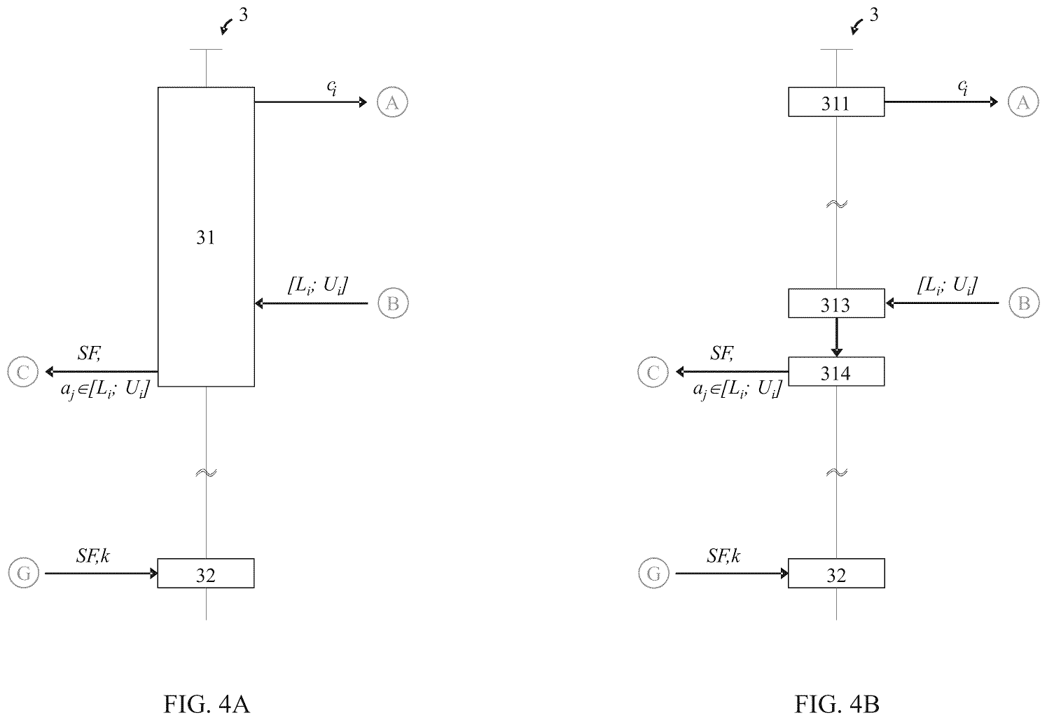

FIGS. 4A, 4B illustrate a protocol behavior of a server device 3 in accordance with the present disclosure at different levels of detail.

Server devices 3 execute service instances SF having assigned respective capacities of cᵢ units of processing.

The server device 3 of FIGS. 4A, 4B comprises one or more of one or more of a plurality of instances i of a service function SF, identified in FIG. 1 as SFᵢ. The one or more instances i respectively have a normalized capacity cᵢ of processing units relative to a normative capacity of processing, such as respective processing rates (see above).

The server device 3 further comprises a control unit (not shown). The control unit is configured to perform a sequence of steps numbered 31 and 32 in FIG. 4A. In more detail:

The control unit is configured to: establish 31 a first forwarding state for an initial packet of a flow of packets to the one or more instances i of the service function.

The first forwarding state comprises a unique index aⱼ of a normalized capacity cᵢ of processing units of the one or more instances i of the service function.

So as to establish 31 the first forwarding state to the one or more instances i of the service function, the control unit may further be configured to: advertise 311 the respective normalized capacity cᵢ of processing units of the one or more instances i of the service function, as is indicated in FIGS. 4A, 4B by outgoing signal/message (A); receive 313 an advertised unique index aⱼ of a normalized capacity cᵢ of processing units of the one or more instances i of the service function, as is indicated in FIGS. 4A, 4B by incoming signal/message (B); and advertise 314 the respective unique index aⱼ and a semantic identifier SF of the service function, as is indicated in FIGS. 4A, 4B by outgoing signal/message (C).

As such, the respective service instance SFᵢ of the service function SF (or the server device 3 executing the service instance SFᵢ on behalf thereof) is configured to advertise the normalized capacity cᵢ of processing units of the respective instance SFᵢ, to receive a set of unique indices aⱼ∈[Lᵢ; Uᵢ] associated with the individual units of the normalized capacity cᵢ, and to advertise the unique indices aⱼ and thus enable formation of first forwarding state in the routing devices 1, 2 of the communication network. It will be appreciated that the latter advertisement may be realized through routing protocols like BGP or similar.

As a result, each routing device 1, 2 receiving the advertisements may form first forwarding state in the form of a routing table comprising cᵢ=Uᵢ−Lᵢ next-hop entries—one for each unique index aⱼ∈[Lᵢ; Uᵢ]—to service instance SF the respective entry comprising a unique index aⱼ, the corresponding service identifier SF, and a next-hop address NH determined by the receiving routing device 1, 2.

The control unit is further configured to: receive 32 a packet of the flow of packets, as is indicated in FIGS. 4A, 4B by incoming signal/message (G). The packet comprises the semantic identifier SF of the service function as the destination address.

The technical effects and advantages described above in relation with the server device 3 equally apply to a method of operating a server device 3 having corresponding features.

FIGS. 5A, 5B illustrate a protocol behavior of a service management device 4 in accordance with the present disclosure at different levels of detail.

The service management device 4 may be implemented as a possibly centralized, possibly service-specific service management entity. The service management device 4 uses knowledge of all service instance processing capabilities (in units) to assign sets of unique indices aⱼ to the service instances SF of a service function SF.

The service management device 4 comprises a control unit (not shown). The control unit is configured to perform a step numbered 41 in FIG. 5A. In more detail:

The control unit is configured to: establish 41 a first forwarding state for an initial packet of a flow of packets to one or more of a plurality of instances i of a service function.

The first forwarding state comprises a unique index aⱼ of a normalized capacity cᵢ of processing units of the one or more of a plurality of instances i of the service function.

So as to establish 41 the first forwarding state to the one or more of a plurality of instances i of the service function, the control unit may further be configured to: receive 411 the respective normalized capacity cᵢ of processing units of the one or more of a plurality of instances i of the service function, as is indicated in FIGS. 5A, 5B by a respective number of incoming signals/messages (A); form 412 a tuple comprising an element of a normalized capacity cᵢ of processing units of the one or more of a plurality of instances i of the service function; and send 413, to the respective instance i of the one or more of a plurality of instances i of the service function, a unique index aⱼ of each element of the tuple that is associated with the respective instance i.

A tuple as used herein may relate to a finite ordered list (sequence) of elements, wherein each element has an index value that is unique within the scope of the list.

Accordingly, the unique indices aⱼ relating to a service function SF may form a continuous interval [1, J] of unique integer values with J representing the total normalized capacity cᵢ of processing units across all service instances SFᵢ, i.e., J=Σ_{i=1, . . . ,I}, (cᵢ). Similarly, the unique indices aⱼ relating to a particular service instance SF of the service function SF may represent a sub-interval [Lᵢ, Uᵢ] where a size of the interval corresponds to the normalized capacity c of processing units advertised by the particular service instance SFᵢ, i.e., Uᵢ−Lᵢ=cᵢ. Each instance-specific sub-interval may be signaled/advertised to the respective service instance, either per index aⱼ or as a whole, thereby minimizing signaling overhead.

It may be appreciated that assignment of processing capabilities to intervals could be done not only via network/service management, but also via service-specific schedulers, realizing the signaling to service instances at the application layer.

The technical effects and advantages described above in relation with the service management device 4 equally apply to a method of operating a service management device 4 having corresponding features.

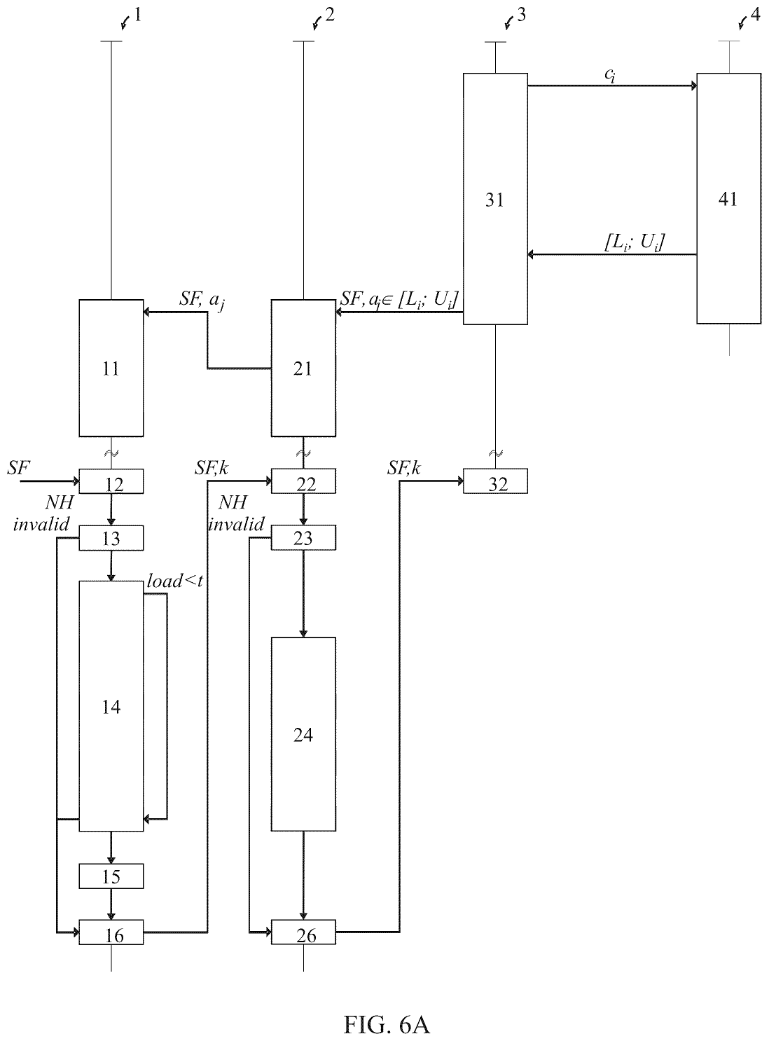

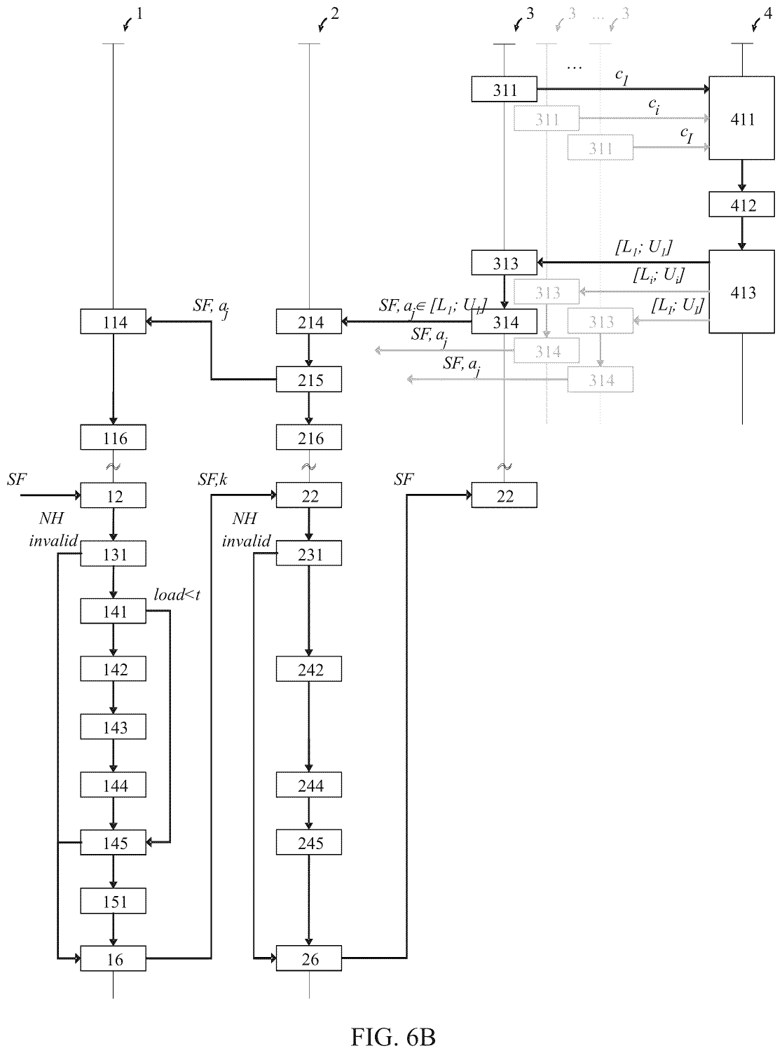

FIG. 6A, 6B illustrate an interaction of the devices 1-4 of FIGS. 2a-5b at different levels of detail.

It will be appreciated that the devices and methods provided could alternatively be designed as an ingress-destination architecture (https://tools.ietf.org/html/draft-li-rtgwg-cfn-dyncast-architecture-00), wherein an ingress routing device 1 would hold destination addresses instead of next-hop addresses, and the role of common routing devices 2 would then be that of an egress node towards the locally attached service instances.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A routing device for routing a flow of packets to a service function, the routing device comprising:
a controller configured to:
establish a first forwarding state for forwarding an initial packet of the flow of packets to one or more of a plurality of instances of the service function, the first forwarding state comprising a unique index of a normalized capacity of processing units of the one or more of the plurality of instances of the service function; and
receive a packet of the flow of packets, the packet comprising a semantic identifier identifying a service function, wherein the semantic identifier is indicative of a destination address; and
perform, based on the received packet not matching a second forwarding state for subsequent packets of the flow of packets,
establishing the second forwarding state to a particular one of the one or more of the plurality of instances of the service function,
preparing to send the received packet to a next hop towards the particular one of the one or more of the plurality of instances of the service function in accordance with the first forwarding state, and
sending the received packet to the next hop in accordance with the first forwarding state; or
perform, based on the received packet matching the second forwarding state,
preparing to send the received packet to the next hop towards the particular one of the one or more of the plurality of instances of the service function in accordance with the second forwarding state; and
sending the received packet to the next hop in accordance with the second forwarding state.

2. The routing device of claim 1, wherein the controller is further configured to establish the first forwarding state to the one or more of the plurality of instances of the service function, wherein the establishing the first forwarding state comprises:
receiving, from an adjacent device, an advertised unique index for a respective unit of the normalized capacity of processing units of the particular one of the one or more of the plurality of instances of the service function, and a semantic identifier of the service function; and
populating a routing table with the semantic identifier of the service function, the unique index and the adjacent device as a next hop.

3. The routing device of claim 2, wherein the controller is further configured to establish the first forwarding state to the one or more of the plurality of instances of the service function, wherein establishing comprises re-advertising the unique index and the associated semantic identifier.

4. The routing device of claim 1, wherein the controller is further configured to prepare to send the received packet to the next hop towards the particular one of the one or more of the plurality of instances of the service function in accordance with the second forwarding state, wherein the preparing comprises:
retrieving the next hop from an instance table in dependence on the received semantic identifier of the service function and a forwarding information of a header of the packet as an identifier of the particular one of the one or more of the plurality of instances of the service function.

5. The routing device of claim 1, wherein the controller is further configured to establish the second forwarding state to the particular one of the one or more of the plurality of instances of the service function in accordance with the first forwarding state, wherein the establishing comprises:
comparing a respective processing load of any local instances of the one or more of the plurality of instances of the service function with a given threshold, the respective local instance being identified by a reception of its unique indices via a local link; and
based on the processing load of a particular one of the local instances not exceeding the given threshold, populating the instance table with the semantic identifier of the service function, the forwarding information of the header of the packet as the identifier of the particular one of the local instances, and a destination address of the particular one of the local instances as the next hop.

6. The routing device of claim 1, wherein the controller is further configured to establish the second forwarding state to the particular one of the one or more of the plurality of instances of the service function in accordance with the first forwarding state, wherein the establishing comprises:
retrieving an instance iterator associated with the semantic identifier of the service function from the routing table, the instance iterator being configured to iterate through the unique indices associated with the semantic identifier of the service function in the routing table; and
storing the instance iterator in the routing table.

7. The routing device of claim 1, wherein the controller is further configured to establish the second forwarding state to the particular one of the one or more of the plurality of instances of the service function in accordance with the first forwarding state, wherein the establishing comprises retrieving an instance iterator associated with the semantic identifier of the service function from the received packet.

8. The routing device of claim 6, wherein the controller is further configured to establish the second forwarding state to the particular one of the one or more of the plurality of instances of the service function in accordance with the first forwarding state, wherein the establishing comprises:
retrieving the next hop from the routing table in dependence on the semantic identifier of the service function and the instance iterator as the unique index; and
populating the instance table with the semantic identifier of the service function, the forwarding information of the header of the packet as the identifier of the particular one of the one or more of the plurality of instances of the service function, and the retrieved next hop.

9. The routing device of claim 6, wherein the controller is further configured to prepare the sending of the received packet to the next hop towards the particular one of the one or more of the plurality of instances of the service function in accordance with the first forwarding state, wherein the preparing comprises:
inserting the instance iterator into the packet.

10. A method of operating a routing device, the method comprising:
establishing a first forwarding state for an initial packet of a flow of packets to one or more of the plurality of instances of a service function, the first forwarding state comprising a unique index for each unit of a respective normalized capacity of processing units of the one or more of the plurality of instances of the service function;
receiving a packet of the flow of packets, the packet comprising a semantic identifier of a service function as a destination address; and
performing, based on the received packet not matching a second forwarding state for subsequent packets of the flow of packets:
establishing the second forwarding state to a particular one of the one or more of the plurality of instances of the service function,
preparing to send the received packet to a next hop towards the particular one of the one or more of the plurality of instances of the service function in accordance with the first forwarding state, and
sending the received packet to the next hop in accordance with the first forwarding state; or
performing, based on the received packet matching the second forwarding state,
preparing a sending of the received packet to the next hop towards the particular one of the one or more of the plurality of instances of the service function in accordance with the second forwarding state; and
sending the received packet to the next hop in accordance with the second forwarding state.

11. The method of claim 10, wherein the method is performed by the routing device of claim 1.

12. A server device, comprising:
one or more of a plurality of instances of a service function, the one or more instances respectively having a normalized capacity of processing units relative to a normative capacity of processing; and
a controller configured to:
establish a first forwarding state for an initial packet of a flow of packets to the one or more instances of the service function, the first forwarding state comprising a unique index for each unit of a respective normalized capacity of processing units of the one or more instances of the service function; and
receive a packet of the flow of packets, the packet comprising a semantic identifier of a service function as a destination address.

13. The server device of claim 12, wherein the controller is further configured to establish the first forwarding state to the one or more instances of the service function, wherein the establishing comprises:
advertising the respective normalized capacity of processing units of the one or more instances of the service function;
receiving a unique index for each advertised unit of the respective normalized capacity of processing units of the one or more instances of the service function; and
advertising the respective unique index and a semantic identifier of the service function.

14. A method of operating a server device, the method comprising:
establishing a first forwarding state for an initial packet of a flow of packets to the one or more instances of the service function, the first forwarding state comprising a unique index for each unit of a respective normalized capacity of processing units of the one or more instances of the service function; and
receiving a packet of the flow of packets, the packet comprising a semantic identifier of a service function as a destination address.

15. The method of claim 14, wherein the method is performed by the server device of claim 12.

16. A service management device, comprising:
a controller configured to establish a first forwarding state for an initial packet of a flow of packets to one or more of the plurality of instances of a service function, the first forwarding state comprising a unique index for each unit of a respective normalized capacity of processing units of the one or more of the plurality of instances of the service function.

17. The service management device of claim 16, wherein the controller is further configured to establish the first forwarding state to the one or more of the plurality of instances of the service function, wherein establishing comprises:
receiving the respective normalized capacity of processing units of the one or more of the plurality of instances of the service function;
forming a tuple comprising an element for each unit of the respective normalized capacity of processing units of the one or more of the plurality of instances of the service function; and
sending, to the respective instance of the one or more of the plurality of instances of the service function, a unique index of each element of the tuple that is associated with the respective instance.

18. A method of operating a service management device, comprising:
establishing a first forwarding state for an initial packet of a flow of packets to one or more of the plurality of instances of a service function, the first forwarding state comprising a unique index for each unit of a respective normalized capacity of processing units of the one or more of the plurality of instances of the service function.

19. The method of claim 18, wherein the method is performed by the service management device of claim 16.

20. A computer program, comprising processor-executable instructions which, when executed by a processor, cause the processor to perform the method of any one of claim 10.
